(19) United States
(12) Patent Application Publication
(10) Pub. No.: US 2003/0061284 A1
(43) Pub. Date: Mar. 27, 2003

(54) Methods, systems and computer program products for conducting a virtual product presentation

(76) Inventors: Angelo Mandarino, Raleigh, NC (US); Louis W. Signorelli JR., Wake Forest, NC (US)

Correspondence Address: MYERS BIGEL SIBLEY & SAJOVEC, PO BOX 37428, RALEIGH, NC, 27627, US

(21) Appl. No.: 09/963,745

(22) Filed: Sep. 26, 2001

(51) Int. Cl. G06F 15/16; G06F 17/60

(52) U.S. Cl. 709/204; 705/26

(57) ABSTRACT

Methods, systems and computer program products for conducting a virtual product presentation are provided. Voice communications are established between a sales representative at a first computer and a customer at a remote second computer coupled to the first computer. Respective first and second displays of a three-dimensional product presentation space are generated at respective ones of the first and second computers. Navigation of the three-dimensional product presentation space at the second computer is controlled from the first computer while maintaining the voice communications between the sales representative and the customer. Generation of the respective first and second displays of a three-dimensional product presentation space may occur responsive to authorization of access to the three-dimensional product presentation space from the second computer, e.g., by software key and/or password credentials transmitted from the second computer to a web server or other data processing apparatus that implements the virtual product presentation space.

### FIELD OF THE INVENTION

This invention relates to computer systems, methods and computer program products, and more particularly to graphical computer systems, methods and computer program products.

### BACKGROUND OF THE INVENTION

Durable goods, such as industrial equipment, may be sold using a variety of different sales channels. For example, “big ticket” items, e.g., items costing several thousands of dollars or more, are often purchased through sales representatives that are employed directly by the manufacturer. For such sales efforts, custom techniques are often employed, that is, one or more company salespersons generate presentations, travel to customer sites, arrange customer plant visits, and undertake other sales efforts that are tailored to closing a deal with a specific big-ticket customer. On the other end of the spectrum, lesser value commodity items are often sold through mass distribution channels, for example, through mass resellers or highly automated shopping websites.

Between these two extremes lies a class of products for which neither of these sales techniques are particularly well-suited, i.e., products having prices that tend to discourage “faceless” transactions through websites and other mass sales channels but that do not justify expensive custom sales efforts. Such products have traditionally been sold using independent sales representatives. These independent sales representatives commonly carry multiple product lines of multiple manufacturers. They typically serve as middlemen who can help determine customer needs, field customer questions, and handle sales transactions on a commission basis.

Although such independent sales representatives can be effective in generating and managing sales, their existence as mediators between the manufacturer and the customer can be problematic for the manufacturer. For example, because of the independence of such sales representatives, it is often difficult to maintain uniformity of sales presentations. It also may be difficult to determine differences in effectiveness among such independent sales representatives, as the manufacturer typically is not present at meetings with customers and, thus, typically cannot gauge the effectiveness of the independent sales representative's presentation and follow-up. It also may be difficult for a manufacturer to gain valuable marketing data when customer transactions are mediated by such independent middlemen, as the manufacturer often has limited access to information gained by these independent representatives in their contacts with customers.

### SUMMARY OF THE INVENTION

According to various embodiments of the invention, methods, systems and computer program products for conducting a virtual product presentation are provided. Voice communications are established between a sales representative at a first computer and a customer at a remote second computer coupled to the first computer. Respective first and second displays of a three-dimensional product presentation space are generated at respective ones of the first and second computers. Navigation of the three-dimensional product presentation space at the second computer is controlled from the first computer such that, for example, the sales representative may guide the customer's view of the product presentation space to a particular product demonstration, interactive application, or the like, based on verbal feedback from the customer received over the voice communications link. Generation of the respective first and second displays of a three-dimensional product presentation space may occur responsive to authorization of access to the three-dimensional product presentation space from the second computer, e.g., by software key and/or password credentials transmitted from the second computer to a web server or other data processing apparatus that implements the virtual product presentation space.

In some embodiments of the invention, voice communications may be established over a telephone network. In other embodiments, voice communications and control of navigation of the three-dimensional product presentation space occurs via a common computer network. In some embodiments of the invention, the three-dimensional product presentation space comprises one or more product presentation rooms. A representation of a product may be provided within a product presentation room, along with other presentation graphics, such as schematic views of a product, displays of specification or other information associated with the product, screen displays for displaying video clips or animated presentations associated with the product, and an interactive whiteboard for accepting customer input relating to the product. Information associated with navigation in the three-dimensional product presentation space, such as a navigation history or whiteboard input, may be stored for later retrieval and analysis.

Embodiments of the invention can offer several advantages over conventional techniques for presenting products, such as conventional customer-navigated websites or conventional sales calls. For example, in some embodiments of the invention, a virtual product presentation among a customer, an independent sales representative and a manufacturer's sales representative may be conducted. Pacing of the virtual product presentation can be controlled by the manufacturer's representative responsive to the verbal feedback provided over the voice communications link. The manufacturer's representative can compensate for a lack of knowledge and/or technical expertise on the part of the independent sales representative, and can reduce the likelihood that the independent sales representative will drift in his sales pitch or make factual misstatements to the customer. Because the manufacturer's representative controls the presentation and can record events associated with the presentation, the manufacturer can more clearly evaluate the performance of the independent sales representative and may obtain valuable marketing information with limited mediation by the independent sales representative.

In some embodiments of the invention, access to the virtual product presentation space can be limited by security credentials and can be controlled by the manufacturer's representative, thus providing relatively secure use of a presentation that includes internal product details, schematics, and specifications that the manufacturer might not want to make available to the general public. In addition, access constraints can be used to ensure that a sales representative is present at the customer site to provide face to face contact with the customer when the product presentation ends and it is time to close a sale. Marketing research indicates that such face to face contact can be extremely valuable in closing sales, particularly for items having prices sufficiently high to inhibit purchases from an impersonal source, such as a conventional shopping website.

### BRIEF DESCRIPTION OF THE DRAWINGS

FIG. 1 is a schematic diagram illustrating a system for conducting a virtual product presentation according to embodiments of the invention.

FIG. 2 is a schematic diagram illustrating a virtual product presentation room according to embodiments of the invention.

FIG. 3 is a schematic diagram illustrating components of a system for conducting a virtual product presentation according to embodiments of the invention.

FIGS. 4-6 and 7A-7D are flowcharts illustrating exemplary operations for conducting a virtual product presentation according to embodiments of the invention.

FIGS. 8-11 are computer screen shots illustrating exemplary navigation of a virtual product presentation room according to embodiments of the invention.

### DETAILED DESCRIPTION

The present invention now is described more fully hereinafter with reference to the accompanying drawings, in which typical embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention involve conducting a virtual product presentation between a customer and a sales representative at geographically separate locations. The invention may be advantageously practiced using computers, e.g., personal computers, laptop computers, notebook computers, computer workstations, personal digital assistants (PDAs), and the like, connected by a network, such as the Internet. The Internet is a worldwide decentralized network of computers having the ability to communicate with each other. The Internet has gained broad recognition as a viable medium for communicating and for conducting business. The World-Wide Web (Web) was created in the early 1990's, and is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. A Web server (also referred to as an HTTP server) is a computer program that generally utilizes HTTP to serve files that form Web pages to requesting Web clients. Exemplary Web servers include International Business Machines Corporation's family of Lotus Domino® servers, the Apache server (available from www.apache.org), and Microsoft's Internet Information Server (IIS), available from Microsoft Corporation, Redmond, Wash. A Web client is a requesting program that also generally utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

Although embodiments of the invention described herein are implemented using computers linked to one another via a Web server, it will be appreciated that the invention can be implemented using any of a number of different types of network configurations, such as a more traditional terminal/host configuration. It will be further appreciated that the invention may, in general, be implemented using a variety of different communications technologies, including wireline, optical and wireless communications technologies.

As will be appreciated by one of skill in the art, the present invention may be embodied as methods, data processing systems, and/or computer program products. Accordingly, the present invention may take the form of an entirely hardware embodiment or an embodiment combining software and hardware aspects. Furthermore, the present invention may take the form of a computer program product on a computer-usable storage medium having computer-usable program code embodied in the medium. Any suitable computer readable medium may be utilized, including, but not limited to, hard disks, CD-ROMs, optical storage devices, or magnetic storage devices.

Computer program code for carrying out operations of the present invention may be written in an object oriented programming language such as JAVA®, Smalltalk or C++. The computer program code for carrying out operations of the present invention may also be written in conventional procedural programming languages, such as “C”, JavaScript, Visual Basic, TSQL, Perl, or in a functional (or fourth generation) programming language such as Lisp, SML, or Forth. The program code may execute entirely on one computer, or may be executed in part on each of a plurality of computers. A variety of different conventional software tools may be used in creating a three-dimensional space as described herein, such as those referenced by Macromedia® Shockwave® and Director® (described at www.macromedia.com), 3DVillage Walking Tour® (described at www.3dvillage.com), and Adobe® Atmosphere® (described at www.adobe.com).

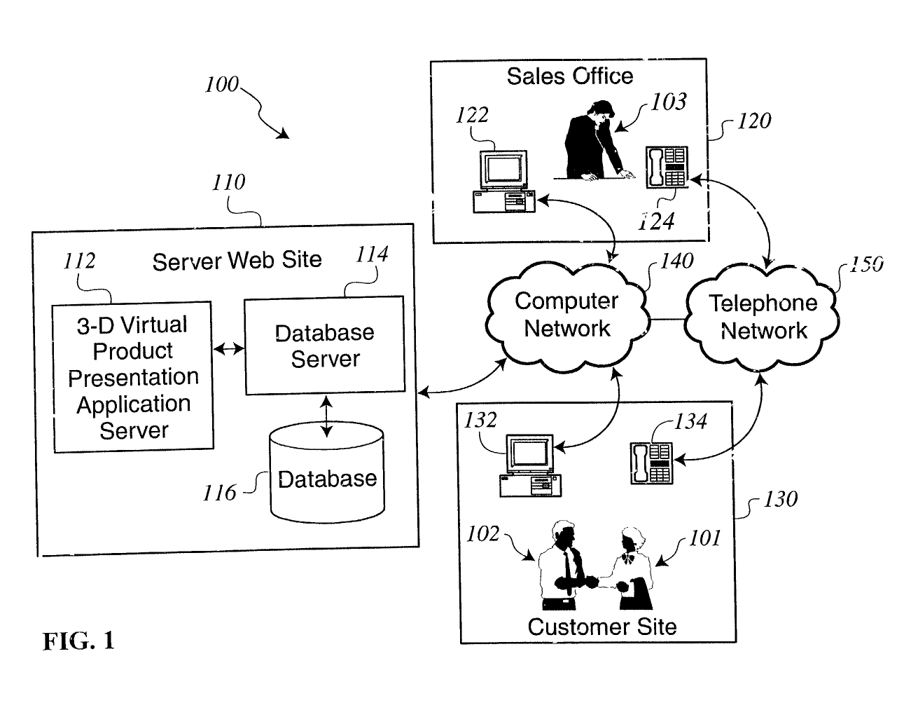

FIG. 1 illustrates a system 100 that can practice methods and/or include computer program products for conducting a sales meeting according to embodiments of the invention. The illustrated system 100 includes a server Web site 110 that communicates with a first computer 122 located at a sales office 120 and a second computer 132 located at a customer site 130 via a computer network 140 (e.g., an internet). The system 100 further includes voice communications apparatus, here shown as first and second telephones 124, 134 linked by a telephone network 150, that provides voice communications between the sales office 120 and the customer site 130.

The Web site 110 includes a 3-D virtual product presentation application server 112, a database server 114, a database 116. Although a single application server 112 and database server 114 are illustrated, it will be understood that other servers may be utilized according to the present invention. The virtual product presentation application server 112 is configured to handle inputs from the first and second computers 122, 132, and may include program code, logic and graphics, to interface with the computers 122, 132 to implement a three-dimensional virtual product presentation space at the first and second computers 122, 132 for use in conjunction with the voice communications devices 124, 134 in conducting a virtual product presentation according to embodiments of the invention. As shown in FIG. 1, the virtual product presentation may be conducted among a customer 101 at the customer site 130, a first sales representative 102, e.g., an independent sales representative, at the customer site 130, and a second sales representative 103, e.g., a manufacturer's sales representative, at the sales office 120. As described in greater detail below, the virtual product presentation application server 112 allows the second sales representative 103 to control navigation by the customer computer 132 through the three-dimensional product presentation space.

It will be appreciated that the system 100 of FIG. 1 is provided for purposes of illustration, and that the invention is not limited to the illustrated configuration. For example, although FIG. 1 illustrates the use of desktop computers 122, 132, the invention may be implemented using other computing devices, including, but not limited to, computer workstations, laptop computers, notebook computers, tablet-type computers and personal digital assistants (PDAs). Instead of using the client-server configuration illustrated in FIG. 1, the invention may use, for example, a more traditional host/terminal configuration wherein first and second terminals are provided at respective ones of the sales office 120 and the customer site 130, and wherein a mainframe computer (not shown) is provided to execute the presentation graphics, security and other features required to implement the three-dimensional virtual product presentation space. Although separate telephone and computer networks 140, 150 are illustrated in FIG. 1, these functions may merged into a common network using, for example, voice over IP or other voice communications technologies. Video, text and other types of communications links may also be provided between the sales office 120 and the customer site 120.

“Sales office” is intended to cover any location at which a seller's representative may conduct the virtual product presentation. For example, the “sales office” may comprise a site located on a corporate campus or similar company-owned location, or a location outside of such a company-operated location, such as a facility belonging to an independent sales entity or a home location of a sales consultant. Similarly, a “customer site” may comprise any customer location, including, but not limited to, the actual business premises of a customer or a location which a customer may visit to engage in the virtual product presentation, such as an office of an independent sales representative or a booth at a trade show.

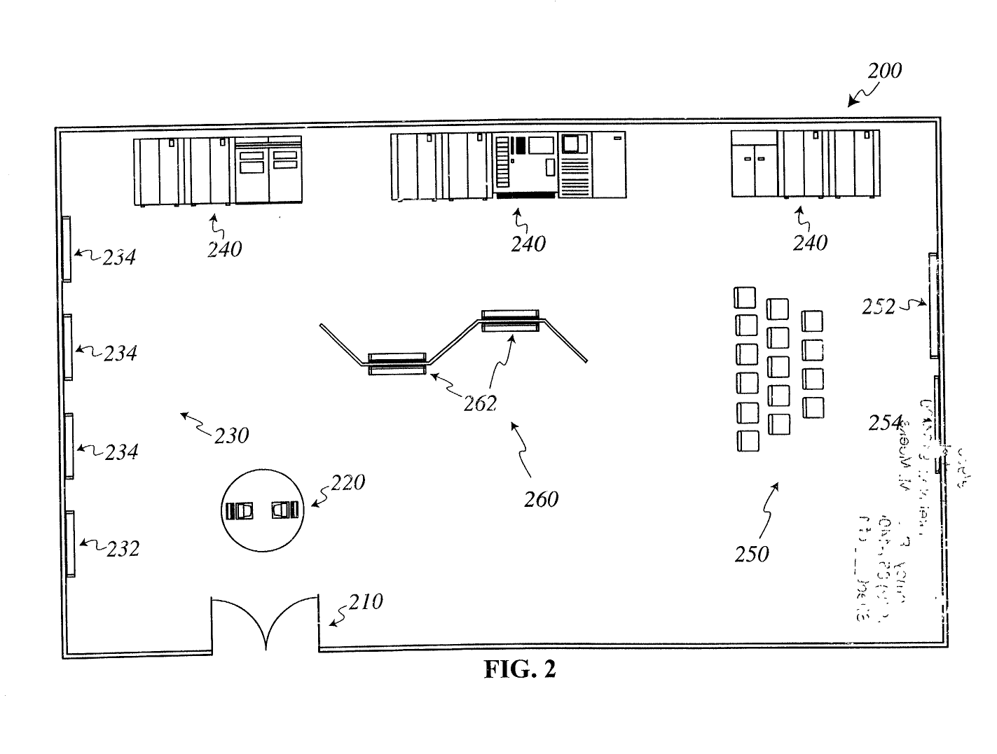

FIG. 2 is a floorplan of an exemplary three-dimensional product presentation space that may be implemented by the system 100 of FIG. 1 according to embodiments of the invention. In particular, a virtual product presentation room 200 includes an entrance, graphically represented as a doorway 210 that opens upon a reception area 220. Adjacent the entrance 210 is a presentation area 230, including a screen 232 for displaying a corporate overview presentation, e.g., a video clip, Shockwave™ presentation, or the like, and screens 234 for similarly displaying presentations on product features. Further included in the demonstration room 200 are exemplary product configurations 240, for example, exemplary equipment setups. The exemplary product configurations 240 may be used for product presentation purposes, such as demonstrations of simulated operation, cutaway views, product specification displays, and the like. The room 200 also includes a theater area 250 including a presentation screen 252 and a whiteboard screen 254 that may be used to provide interactive presentations including input from both the customer computer 132 and the sales office computer 122. The room further includes an interface portal area 260 including screens 262 that may be used to access other applications, websites for related companies and/or products, or the like.

It will be appreciated that the product presentation space 200 is offered for purposes of illustration, and that the invention is not limited to the configuration illustrated in FIG. 2. For example, a virtual product presentation space according to other embodiments of the invention may comprise more than one room, and may include features other than or in addition to the features described with reference to FIG. 2. In addition, a virtual product demonstration space according to other embodiments of the invention may utilize a three-dimensional space metaphor other than a room, such as a open-air market, industrial site, or the like.

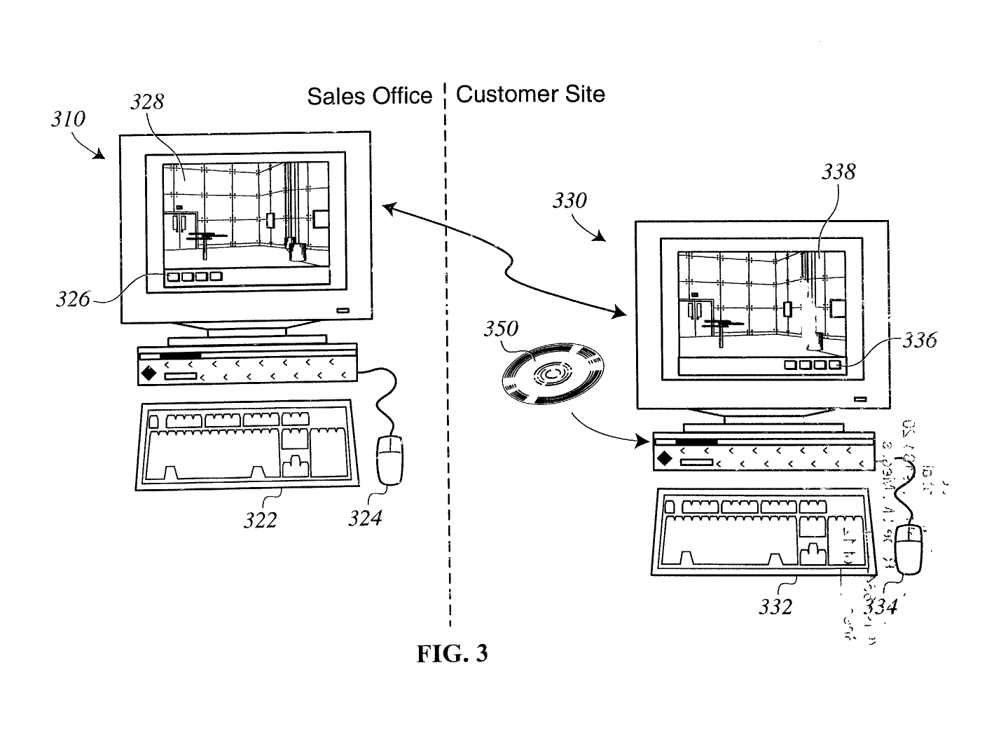

FIG. 3 illustrates a sales office computer 310 and a customer site computer 330 according to some embodiments of the invention. The sales office computer 330 provides a user interface including a display area 328 for displaying a three-dimensional virtual product presentation space, as well as user input devices, such as a keyboard 322 and display buttons 326 that may be actuated using a mouse 324 or similar device. Similarly, the customer site computer 330 includes a display area 338 for displaying the three-dimensional virtual product presentation space, and user input devices, such as a keyboard 332 and display buttons 336 that may be actuated using a mouse 334 or similar device. As shown, the customer site computer 330 further includes a storage medium, here shown as a CD-ROM 350, that provides appropriate program code to support presentation graphics for displaying the virtual product presentation space, as well as security credentials needed to access the product presentation space.

The user interface provided at the sales office computer 310 differs from the user interface at the customer site computer 330. In particular, the user interface at the sales office computer 310 may include functionality that enables the sales office computer 310 to control navigation of the virtual product presentation space at the customer site computer 330, while the user interface at the customer site computer 330 may provide different, e.g., lesser, control of the presentation space.

It will be appreciated that the configuration of FIG. 3 is offered for illustrative purposes, and that other configurations may be used with the invention. For example, as described above, the computers 310, 330 may take forms other than the illustrated desktop configurations, and may include other user input devices, such as trackballs, joysticks, touch screens, digitizing pads or the like. Depending on the bandwidth of the communications link between the computers 310, 330, the CD-ROM may be eliminated in favor of providing presentation graphics via the communications link, and security via other means, such as secure passwords or encryption keys.

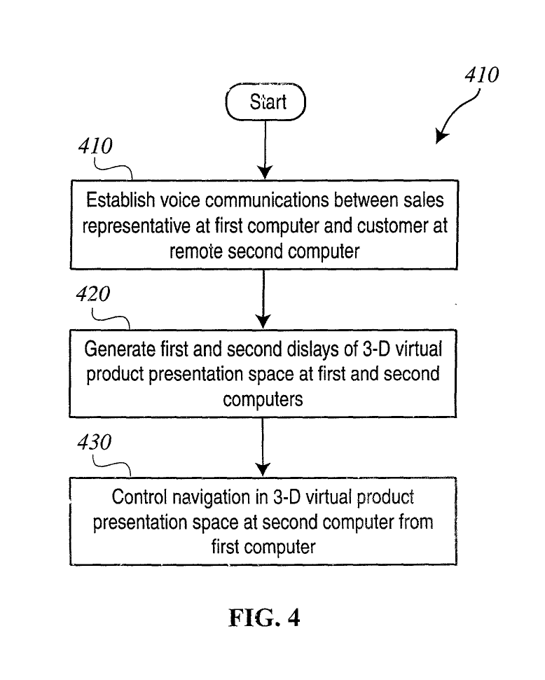

FIGS. 4-7 are flowchart illustrations of methods, apparatus (systems) and computer program products according to an embodiment of the invention. It will be understood that each block of the flowchart illustrations, and combinations of blocks, can be implemented by computer program instructions. These computer program instructions may be provided to a processor of a general purpose computer, special purpose computer, or other programmable data processing apparatus, such as the computers 120, 130 and/or server 110 of FIG. 1, to produce a machine, such that the instructions, which execute via the processor of the computer or other programmable data processing apparatus, create structures for implementing the functions specified in the block diagram and/or flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks. The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

FIG. 4 illustrates exemplary operations 400 for conducting a virtual product presentation according to embodiments of the invention. Voice communications are established between the sales representative at a first computer (e.g., a computer at a manufacturer's sales office), and a customer at a remotely located second computer (Block 410). First and second displays of a three-dimensional product space are generated at respective ones of the first and second computers (Block 420). Navigation of the product presentation space at the second computer is controlled from the first computer (Block 430). For example, responsive to the voice communications with the customer, the seller may provide user input to the first computer using, for example, a mouse, joystick, trackball or other user interface, such that the seller's and the customers screen displays concurrently navigate through the three-dimensional product presentation space to particular features of the space.

It will be appreciated that the operations 400 can be implemented in number of ways within the scope of the invention. In general, voice communications may be established before, after, or concurrently with generation of the three-dimensional product space. For example, in embodiments in which a conventional telephone connection is utilized, voice communications may be established before or after establishment of the virtual product presentation space. In embodiments in which voice communications are integrated with the computer communications between the first and second computers using voice over IP or other voice communications technologies, voice communications and the virtual product presentation space may be established in a substantially simultaneous fashion. As described below, access to the three-dimensional product presentation space may controlled by use of security credentials, and navigation of the three-dimensional product presentation space may involve any of a variety of graphical presentation operations.

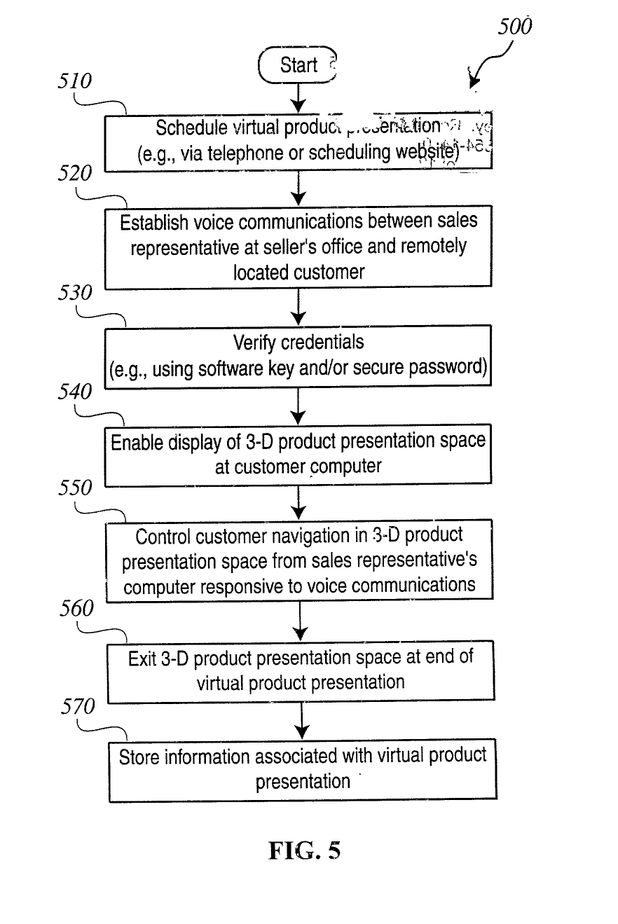

FIG. 5 illustrates exemplary operations 500 for conducting a virtual product presentation between a customer and a seller according to some embodiments of the invention. A virtual product presentation is scheduled (Block 510). For example, the virtual product presentation may be scheduled in a largely manual fashion via a simple telephone call that sets a time for conducting the virtual product presentation. Alternatively, the scheduling process may be automated using a scheduling website, e-mail or other means.

At the scheduled meeting time, voice communications between the customer and the seller are established (Block 520) by, for example, placing a telephone call or establishing voice communications over a computer network. Credentials for the customer to access a three-dimensional product presentation area are verified (Block 530) by, for example, transmitting credentials from the customer's computer using a password or other security identification and/or a software key embodied in a CD-ROM or other portable storage medium. Responsive to verification of the credentials, display of the three-dimensional product presentation space at the seller's computer and the customer's computer is enabled (Block 540). Customer navigation through the product presentation space is then controlled by the seller's computer responsive to voice communications between the seller and the customer (Block 550). For example, based on specific information gained from the customer over the voice communications link, the seller may navigate the customer to particular features of the product presentation space. Upon exit from the product presentation space (Block 560), information associated with the virtual product presentation is stored for later retrieval by the customer, for analysis by the seller, or for other purposes (Block 570).

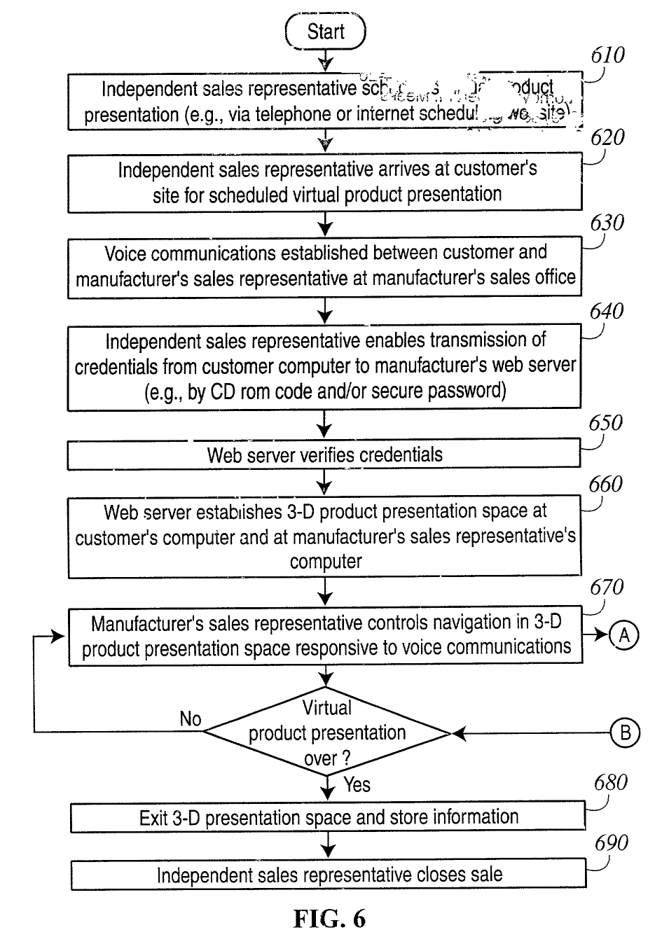

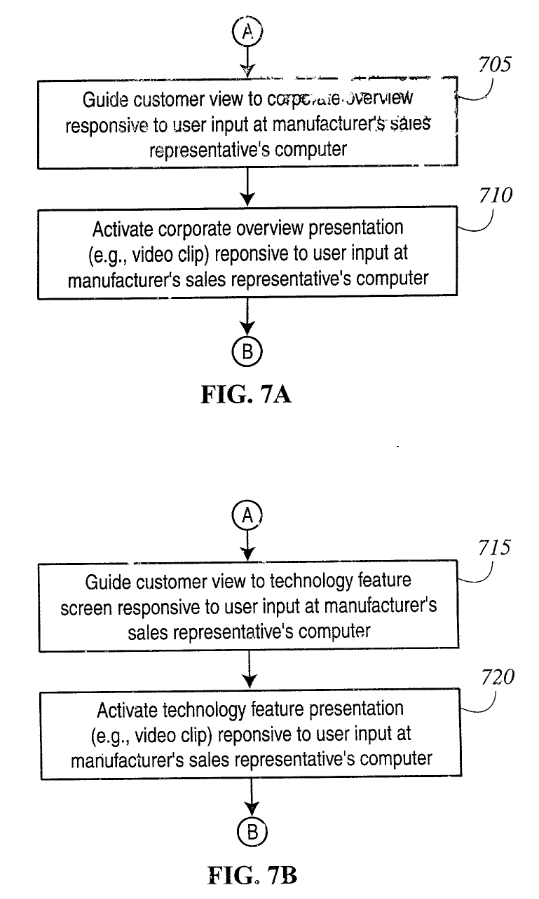

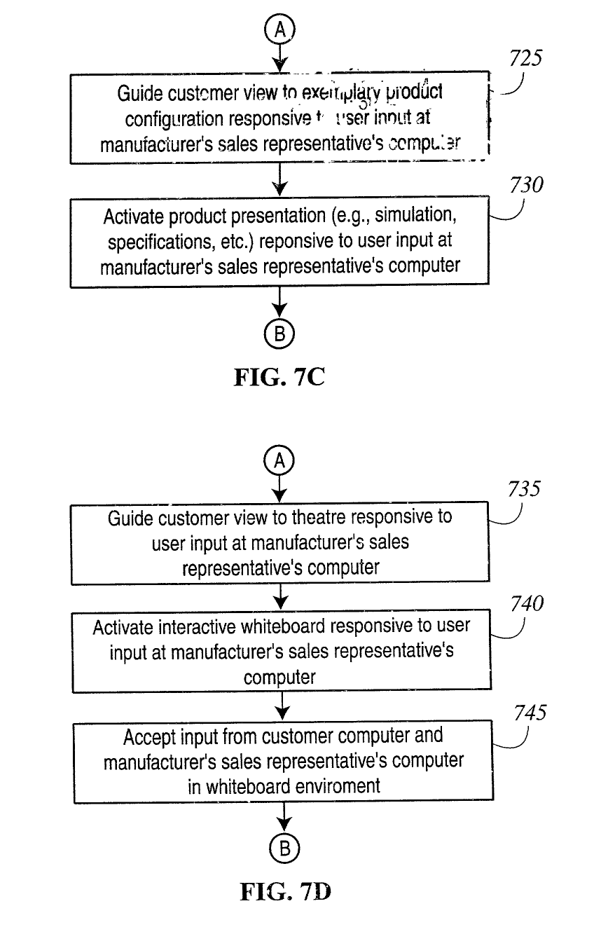

FIGS. 6 and 7 illustrate exemplary operations according to other embodiments of the invention, and more particular, operations for conducting a virtual product presentation among a customer, an independent sales representative and a manufacturer's representative. The independent sales representative schedules the virtual product presentation by, for example, calling the customer and the manufacturer's representative, or by using more automated scheduling means, such as a web-based scheduling program (Block 610). On the appointed day, the independent sales representative calls at the customer's site (Block 620) and establishes voice communications with the manufacturer's representative at the manufacturer's sales office (Block 630). The independent sales representative enables transmission of security credentials from the customer site computer, which may comprise, for example, a computer owned by the customer or a portable computer (e.g., laptop) provided by the independent sale representative (Block 640). A web server that supports the virtual product presentation application verifies the transmitted credentials (Block 650) and then establishes a three-dimensional product presentation space at the manufacturer's representative's computer and at the customer site computer (Block 660).

During the virtual product presentation, the manufacturer's representative controls navigation in the product presentation space by, for example, providing appropriate user inputs at his computer (Block 670). Such navigation may be guided based on voice communications over the voice communications link between the manufacturer's sales office and the customer site. For example, during the presentation, the customer may express particular questions, interests or needs and, responsive to this expression, the manufacturer's representative may steer the customer through the product presentation space to appropriate presentation elements that address these expressed interests, needs or questions, such as screen elements that provide explanatory video clips, product configuration representations, or opportunities for input from the customer.

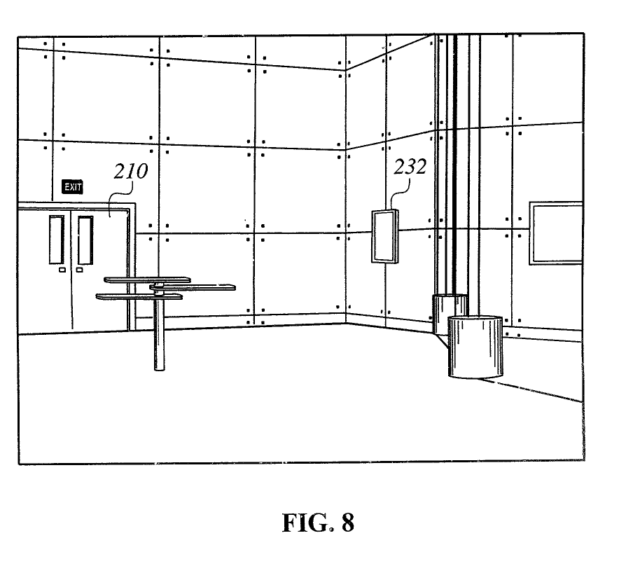

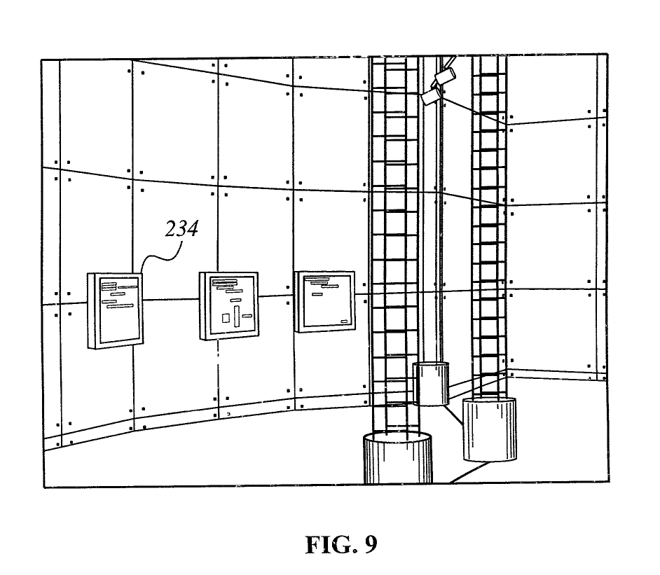

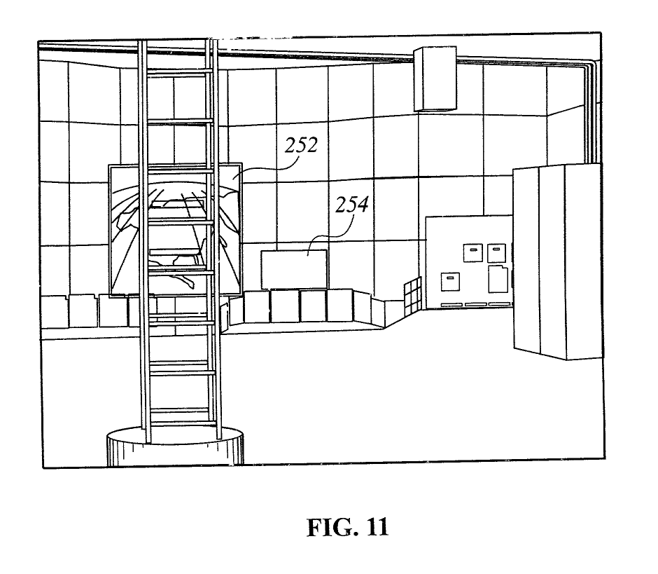

Some examples of navigation operations that may be initiated based on the verbal communication with the customer will now be described with reference to FIGS. 2, 6, 7A-7D and 8-11. Referring to FIGS. 2, 6, 7A and 8, the manufacturer's representative may guide the customer to a corporate overview presentation screen 232 (Block 705). The manufacturer's representative may then activate a corporate overview presentation, e.g., a video clip or Shockwave® presentation, that is displayed on the presentation screen 232 (Block 710). Referring now to FIGS. 2, 6, 7B and 9, the manufacturer's representative may also guide the customer's view to a similar technology feature screen 234 (Block 715), where he may activate a presentation relating to a technology feature, e.g., a feature common to the manufacturer's product line (Block 720).

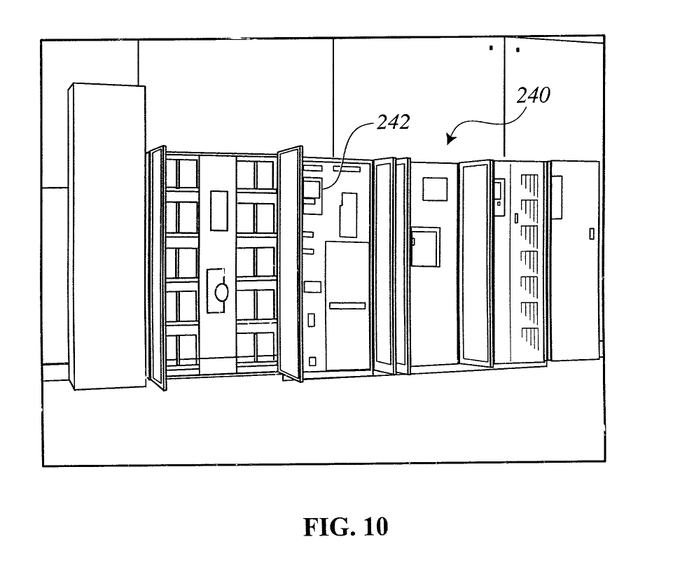

Referring now to FIGS. 2, 6, 7C and 10, the manufacturer's representative may further guide the customer's view to an exemplary product configuration 240 (Block 725), where the manufacturer's representative may activate a product presentation associated with the exemplary product configuration 240 (Block 730). For example, for the uninterruptible power supply (UPS) product configuration illustrated in FIG. 10, this may involve executing a simulation that generates a simulated display on a control panel 242. Other presentations may also be provided, such as displays of performance specifications associated with the product configuration, schematic diagrams associated with the product configuration, cutaway views of internal details of components of the product configuration, cost estimates associated with the product configuration, and the like. These may be activated responsive to a user input from the manufacturer's representative via any of a variety of different user interfaces, such as a toolbar, popup menu, icon selection, or the like.

Referring to FIGS. 2, 6, 7D and 11, the manufacturer's representative may also guide the customer's view to the theatre area 250 (Block 735). The manufacturer's representative may then activate an interactive whiteboard application associated with the whiteboard 254 in the theater area 250 (Block 740). The whiteboard application may comprise any of a number of commercially available virtual whiteboard applications, such as the whiteboard utility provided in Microsoft® Windows NetMeeting®. While in the whiteboard application, inputs may be accepted from both the customer's computer and the manufacturer's representative's computer (Block 745). This feature may be used, for example, to facilitate discussion of the customer's particular needs. For example, for the UPS product environment illustrated, the whiteboard environment may be used to sketch proposed product configurations that use products demonstrated in other portions of the product presentation room 200.

Referring to FIGS. 2 and 6, the manufacturer's representative is free to visit and revisit any area of the product presentation room 200 as desired, or to proceed to termination of the product presentation room 200 (Block 680). The system may store information gained during the virtual product presentation, such as a record (navigation history) of objects visited in the demonstration room 200 during the virtual product presentation, a record of information input during a whiteboard session, or notes electronically entered by the manufacturer's representative during the virtual product presentation, in the manufacturer's database (e.g., a database such as the database 116 of FIG. 1). After conclusion of the virtual presentation, the independent sales representative, who still is at the customer site, can provide followup that may ultimately result in closing a deal for purchase of a product demonstrated during the virtual product presentation (Block 690).

Potential advantages of such an approach are numerous. By guiding the virtual product presentation from the manufacturer's location, pacing of the virtual product presentation can be controlled by the manufacturer's representative responsive to the verbal feedback provided over the voice communications link. This can provide a more focused and, therefore, more effective sales pitch than that provided by a conventional website or a traditional sales call by an independent sales representative. The presence of the manufacturer's representative and his control of navigation of the product presentation space can also compensate for a lack of knowledge and/or technical expertise on the part of the independent sales representative, as the manufacturer's representative may be better equipped to answer detailed customer questions. Moreover, control by the manufacturer's representative can also reduce the likelihood that the independent sales representative will go “off message” or make misstatements to the customer.

Because access to the virtual demonstration space can be limited by security credentials and controlled by the manufacturer's representative, a more feature-rich presentation can be provided, including, for example, internal product details, schematics, and specifications that the manufacturer would not want to make available to the general public (an on-line confidentiality agreement may even be included as part of the access credentialing procedure). In addition, because access can be controlled such that a sales representative must be present at the customer site to conduct the virtual product presentation, embodiments of the invention can ensure face to face contact with the customer when the product presentation ends and it is time to “close the deal.”

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of conducting a virtual product presentation, the method comprising:
establishing voice communications between a sales representative at a first computer and a customer at a remote second computer coupled to the first computer;
generating respective first and second displays of a three-dimensional product presentation space at respective ones of the first and second computers; and
controlling navigation of the three-dimensional product presentation space at the second computer from the first computer.

2. A method according to claim 1, wherein controlling navigation of the three-dimensional product presentation space at the second computer from the first computer comprises controlling navigation of the three-dimensional product presentation space responsive to the voice communications between the sales representative and the customer.

3. A method according to claim 1:
wherein generating respective first and second displays of a three-dimensional product presentation space at respective ones of the first and second computers comprises generating a representation of a product presentation room; and
wherein controlling navigation of the three-dimensional product presentation space at the second computer from the first computer comprises controlling navigation in the product presentation room at the second computer from the first computer.

4. A method according to claim 3, wherein generating a representation of a product presentation room comprises generating a representation of a product within the product presentation room.

5. A method according to claim 1, wherein generating respective first and second displays of a three-dimensional product presentation space is preceded by authorizing access to the three-dimensional product presentation space from the second computer, and wherein generating respective first and second displays of the three-dimensional product presentation space comprises generating the second display at the second computer responsive to authorization of access to the three-dimensional product presentation space from the second computer.

6. A method according to claim 5, wherein authorizing access to the three-dimensional product presentation space from the second computer comprises:
transmitting a credential from the second computer;
verifying the transmitted credential; and
authorizing access to the three-dimensional product presentation space from the second computer responsive to verification of the transmitted credential.

7. A method according to claim 6, wherein transmitting a credential from the second computer comprises transmitting the credential from the second computer responsive to user entry of credential information at the second computer.

8. A method according to claim 1, wherein establishing voice communications comprises establishing voice communications via a telephone network.

9. A method according to claim 1:
wherein establishing voice communications comprises establishing voice communications via a computer network; and
wherein controlling navigation of the three-dimensional product presentation space at the second computer from the first computer comprises controlling navigation of the three-dimensional product presentation space at the second computer from the first computer via the computer network.

10. A method according to claim 1:
wherein generating respective first and second displays of a three-dimensional product presentation space at respective ones of the first and second computers comprises generating a user interface at the first computer for controlling display of the of the three-dimensional product presentation space at the second computer; and
wherein controlling navigation of the three-dimensional product presentation space at the second computer from the first computer comprises accepting input to the user interface at the first computer to control display of the three-dimensional product presentation space at the second computer.

11. A method according to claim 1, wherein generating respective first and second displays of a three-dimensional product presentation space at respective ones of the first and second computers comprises generating a representation of a product, and wherein controlling navigation of the three-dimensional product presentation space at the second computer from the first computer comprises controlling display of the three-dimensional product presentation space at the second computer to navigate to the representation of the product.

12. A method according to claim 11, further comprising displaying a specification associated with the product and/or a schematic representation associated with the product and/or a graphic representation of the product and/or a simulated performance of the product responsive to a user input at the first computer.

13. A method according to claim 1, wherein generating respective first and second displays of a three-dimensional product presentation space at respective ones of the first and second computers comprises generating a graphic representation associated with a technology feature, and wherein controlling navigation of the three-dimensional product presentation space at the second computer from the first computer comprises controlling display of the three-dimensional product presentation space at the second computer to navigate to the graphic representation of the technology feature.

14. A method according to claim 13, further comprising activating a pre-recorded presentation associated with the technology feature responsive to a user input at the first computer.

15. A method according to claim 14, wherein activating a pre-recorded presentation associated with the technology feature responsive to a user input at the first computer comprises activating the pre-recorded presentation responsive to user selection of the graphic representation associated with the technology feature.

16. A method according to claim 1, wherein controlling navigation of the three-dimensional product presentation space at the second computer from the first computer comprises navigating the three-dimensional product presentation space to arrive at an interactive workspace.

17. A method according to claim 16, further comprising accepting user inputs from both of the first and second computers to the interactive workspace.

18. A method according to claim 16, wherein the interactive workspace comprises a white board representation.

19. A method according to claim 1, further comprising storing information associated with navigation in the three-dimensional product presentation space.

20. A method of conducting a virtual product presentation, the method comprising:
conducting voice communications between a manufacturer's sales representative at a sales office and a customer at a customer site;
generating respective first and second displays of a three-dimensional product presentation space at respective ones of the first and second computers at respective ones of the sales office and the customer site; and
accepting user input at the first computer to control navigation of the three-dimensional product presentation space at the second computer responsive to the voice communications between the manufacturer's sales representative and the customer.

21. A method according to claim 20, wherein generating respective first and second displays of a three-dimensional product presentation space is preceded by applying an access credential supplied by an independent sales representative located at the customer site to enable display of the three-dimensional product presentation space at the second computer.

22. A method according to claim 20, wherein the three-dimensional product presentation space comprises a product presentation room.

23. A system for conducting a virtual product presentation, the system comprising:
means for establishing voice communications between a sales representative at a first computer and a customer at a remote second computer networked to the first computer;
means for generating respective first and second displays of a three-dimensional product presentation space at respective ones of the first and second computers; and
means for controlling navigation of the three-dimensional product presentation space at the second computer from the first computer.

24. A system according to claim 23, wherein the means for controlling navigation of the three-dimensional product presentation space at the second computer from the first computer comprises means for controlling navigation of the three-dimensional product presentation space responsive to the voice communications between the sales representative and the customer.

25. A system according to claim 23, further comprising means for authorizing access to the three-dimensional product presentation space from the second computer, and wherein the means for generating respective first and second displays of the three-dimensional product presentation space comprises means for generating the second display at the second computer responsive to authorization of access to the three-dimensional product presentation space from the second computer.

26. A system according to claim 25, wherein the means for authorizing access to the three-dimensional product presentation space from the second computer comprises:
means for transmitting a credential from the second computer;
means for verifying the transmitted credential; and
means for authorizing access to the three-dimensional product presentation space from the second computer responsive to verification of the transmitted credential.

27. A system according to claim 26, wherein the means for transmitting a credential from the second computer comprises means for transmitting the credential from the second computer responsive to user entry of credential information at the second computer.

28. A system according to claim 23, wherein the means for establishing voice communications comprises a telephone network.

29. A system according to claim 23, wherein the means for establishing voice communications comprises and the means for controlling navigation of the three-dimensional product presentation space at the second computer from the first computer comprises a computer network.

30. A system according to claim 23, wherein the three-dimensional product presentation space comprises a product presentation room.

31. A system according to claim 23, further comprising means for displaying a specification associated with a product and/or a schematic representation associated with a product and/or a graphic representation of a product and/or a simulated performance of a product responsive to a user input at the first computer.

32. A system according to claim 23, wherein the means for navigating comprises means for activating a pre-recorded presentation associated with an object in the product presentation space responsive to a user input at the first computer.

33. A system according to claim 23, wherein the means for navigating comprises means for navigating the three-dimensional product presentation space to arrive at an interactive workspace.

34. A system according to claim 33, further comprising means for accepting user inputs from both of the first and second computers to the interactive workspace.

35. A system according to claim 33, wherein the interactive workspace comprises a white board representation.

36. A system according to claim 23, further comprising means for storing information associated with navigation in the three-dimensional product presentation space.

37. A computer program product for conducting a virtual product presentation, computer program product comprising program code embodied in a computer-readable storage medium, the computer program code comprising:
program code for controlling navigation of the three-dimensional product presentation space at the second computer from the first computer concurrent with voice communications between the sales representative and the customer.

38. A computer program product according to claim 37, wherein the computer program code further comprises program code for authorizing access to the three-dimensional product presentation space from the second computer, and program code for generating a display of the three-dimensional product presentation space at the second computer responsive to authorization of access to the three-dimensional product presentation space from the second computer.

39. A computer program product according to claim 38, wherein the program code for authorizing access to the three-dimensional product presentation space from the second computer comprises:
program code for verifying a credential transmitted from the second computer; and
program code for authorizing access to the three-dimensional product presentation space from the second computer responsive to verification of the transmitted credential.

40. A program product according to claim 37, wherein the three-dimensional product presentation space comprises a virtual product presentation room.

41. A program product according to claim 37, wherein the computer program code further comprises program code for storing information associated with navigation in the three-dimensional product presentation space.
